(19) United States
(12) Patent Application Publication
(10) Pub. No.: US 2009/0215343 A1
(43) Pub. Date: Aug. 27, 2009

(54) Coated Woven Fabric or Knit Fabric for a Safety Air Bag

(76) Inventors: Cécile Lopez, Saint Marcel Bel Accueil (FR); Bertrand Bordes, Lyon (FR); Christian Wattenhofer, Buonas (CH)

Correspondence Address: LADAS & PARRY LLP, 26 WEST 61ST STREET, NEW YORK, NY, 10023, US

(21) Appl. No.: 12/085,843

(22) PCT Filed: Dec. 5, 2006
(86) PCT No.: PCT/EP2006/069298

§ 371 Date: Dec. 24, 2008

(30) Foreign Application Priority Data
Dec. 6, 2005 (FR) 05 12346

(51) Int. Cl. D06M 15/263; D06M 15/53; D03D 1/04; D03D 47/30; B60R 21/16

(52) U.S. Cl. 442/97; 428/34.1; 139/435.1; 139/389; 139/420 R; 280/728.1

(57) ABSTRACT

The invention relates to a coated woven fabric or knit fabric for a safety air bag and to the production method thereof. More specifically, the invention relates to a coated woven fabric or knit fabric for a safety air bag, which is obtained using a method that does not involve a sizing step or a washing step and which is produced from threads having a pre-determined amount of a lubricant composition on the surface thereof. The invention also relates to the use of the aforementioned threads in the area involving the production of coated woven or knit fabrics for safety air bags, as well as to a safety air bag comprising said coated woven or knit fabric.

The invention relates to a coated woven fabric or knit fabric for a safety air bag, and a method of obtaining it. The invention relates more particularly to a coated woven fabric or knit fabric for a safety air bag obtained without an adhesive-coating step or a washing step, from yarns having a predetermined quantity of the lubricating composition present on their surface. The invention also relates to the use of these yarns in the field of coated woven fabric or knit fabric safety air bags, as well as to a safety air bag comprising the coated woven or knit fabric.

To ensure the cohesion of yarns intended for weaving, they are usually twisted. However, twisting is increasingly being replaced by an air method of intermingling the filaments. Thus, depending on the pressure of the fluid and the intermingling apparatus, the number of points of cohesion—that is, the number of points where the filaments form a node—can be varied to suit the desired final appearance of the yarn and its subsequent use.

In order to make the fibers and yarns slide well, it is common practice to apply softening oils or products. As far as artificial and synthetic continuous yarns are concerned, these oils and/or softeners are applied to the yarn on one or more occasions during its manufacturing process. These softening oils or products are usually removed after weaving by treatment of the woven fabric in the course of a washing operation. The presence of these softening oils or products can indeed be harmful, particularly in the case of safety air bags: for example, they can reduce the adhesion of the fabric to the protective coating, and can reduce the bag's resistance to fire and heat.

When using warp, principally in weaving, it is known that the yarns rub partly against each other, because of the up and down movement of the heald shafts, and partly against loom components such as the heald eyes through which they pass, reed dents, slay, winding off mechanism, warp stop motion, etc. In order to avoid that the friction causes defects prejudicial to the actual operation of weaving and to the quality of the resulting fabric the yarns are sized beforehand. This well-known treatment of fiber yarns for promoting fiber cohesion and forming a protective sheath around the yarns is also applied to artificial and synthetic continuous multifilament yarns; the sizing must ensure that the filaments, which are generally of fine counts and therefore fragile, are kept in place, and must surround the continuous yarns with a sheath protecting against the friction described above and thereby facilitate the sliding of the yarns not only against the parts of the loom but also between yarns, in order to produce fabrics without visible defects, and minimizing breakages and fraying. These sizing products are usually removed after weaving by a treatment of the woven fabric in the course of a desizing operation. Desizing also removes the softening oils and products present on the yarns. The washing operation referred to above is in this case carried out at the desizing stage.

In order to reduce the cost of sizing and desizing and thus eliminate two yarn handling operations, attempts have been made to dispense with the sizing operation, which furthermore is harmful to the environment. Also, the sizing product can be difficult to remove completely, depending on the type of product used, the type of yarn and the fabric structure, which bears the risk of size residues being left present in the fabric. The presence of these residues can be harmful, especially in the case of safety air bags; for example, it can diminish the performance of the product as it ages and its fire and heat resistance properties.

It is therefore sought to dispense with the sizing and washing operations in the manufacture of fabrics for individual protective bags (“air bags”) for the occupants of vehicles. Removing this sizing and washing step must not however change but maintain the required properties of the fabric in its use as a safety air bag.

There exist two types of base fabric for safety air bags: Fabrics having a protective elastomeric coating layer—such as silicone resin; and fabrics that have no protective elastomeric coating layer, typically for reasons of weight.

Historically, as far as fabrics having a protective coating are concerned, protective bags are made of a cloth made of synthetic fiber such as polyamide (Nylon®) coated on at least one of its faces with a layer of an elastomer of type chloroprene. The air bag (or inflatable cushion) is a folded and compressed polyamide fabric air bag. The presence of such a protective layer or coating is dictated by the fact that the gases released by the gas generator (e.g. carbon monoxide or NOx) in the case of an impact are extremely hot and contain incandescent particles which could damage the Nylon® bag.

Protective silicone coatings are also used: they are usually produced by coating the substrate and then curing it by polyaddition of unsaturated groups (alkenyls, e.g. Si-Vi) of a polyorganosiloxane onto hydrogens of the same or another polorganosiloxane.

The internal elastomeric protective layer and the synthetic fabric support forming the walls of the air bag must among other things adhere thoroughly and must withstand high temperatures and mechanical stresses. Air bags must in particular have good fire and heat resistance properties, besides good crease resistance and abrasion resistance (scrub test).

Therefore, in particular for safety air bags having a protective coating, it is therefore sought to dispense with the sizing operation and washing operation when producing the fabric, while maintaining the fabric properties required for its application as a safety air bag, notably the properties of fire and heat resistance, crease resistance and abrasion resistance (scrub test).

To this end, the present invention provides, as a first object, a coated woven fabric or knit fabric for a safety air bag obtained by coating a basic woven (or knit) fabric with an elastomer on at least one surface of the basic woven (or knit) fabric, the yarns of the basic woven (or knit) fabric having a predetermined quantity of lubricating composition present on their surface.

The invention provides in a second object a method of preparing a coated woven or knit fabric, particularly by a method that does not include any sizing step or any washing step.

The invention provides in a third object the use of yarns having a predetermined quantity of lubricating composition present on their surface, to produce coated woven or knit fabrics for safety air bags.

The invention provides in a fourth object a safety air bag comprising the coated woven or knit fabric.

The invention therefore relates in a first object to a coated woven fabric or knit fabric for a safety air bag, obtained by coating a basic woven or knit fabric with an elastomer on at least one surface of the basic woven or knit fabric, the basic woven or knit fabric being formed of yarns having a lubricating composition on at least part of their surface, the average proportion of lubricating composition (solids content) being from 0.2 to 0.7% by weight (including the boundary values) relative to the weight of the basic woven or knit fabric, preferably from 0.3 to 0.7%. The average proportion of lubricating composition by weight relative to the weight of the basic woven or knit fabric is equal to the average proportion of lubricating composition present on the surface of the yarns forming the basic woven or knit fabric, by weight relative to the weight of the yarns.

In one particular embodiment of the woven or knit fabric of the invention, each yarn forming the woven or knit fabric has a proportion of lubricating composition on its surface of from 0.3 to 0.9% by weight (including the boundary values) relative to the weight of the yarn. A proportion of lubricating composition of less than 0.3% may make spinning and/or weaving of the yarns, fibers or filaments difficult, especially if weaving without the use of size. A proportion of lubricating composition of greater than 0.9% could degrade the final properties of the coated fabric, especially resistance to creasing and abrasion (the scrub test).

The proportion of lubricating composition on the surface of the yarns can be measured by any method known to those skilled in the art, such as an extraction method or an NMR method. The proportion of lubricating composition is advantageously measured by an extraction method according to DIN standard 54278. These measurements can be carried out on the yarns or on the woven or knit fabric.

The lubricating composition present on the surface of the yarns may be a softening composition, and/or a warping oil.

The lubricating composition is advantageously a softening composition.

A softening composition applied to the yarns, fibers or filaments as they are produced helps them to slide well. The proportion of softening composition according to the invention, applied to the yarns, fibers or filaments not only makes them behave well during the operations of spinning, warping and weaving without size, but also results in the production of a coated fabric for a safety air bag that has good final properties, especially in the case of a safety air bag fabric coated with a silicone. The coated fabric has among other things good properties in terms of crease resistance and abrasion resistance (the scrub test), without the need to remove softening composition from the surface of the yarns of the fabric.

Softening compositions suitable for the invention are all softening compositions traditionally used in polymer spinning, especially for spinning polyamide or polyesters. The softening composition may include the following compounds: as lubricants natural or synthetic fatty acids or derivatives of fatty acids such as fatty acid esters; nonionic emulsifiers such as ethoxylated fatty acids, ethoxylated fatty alcohols or an EO/PO polymer; anionic emulsifiers such as phosphates, sulfates or sulfonates; and other additives such as surfactants. The softening compositions are usually aqueous emulsions or oils.

A warping oil applied to warp yarns intended for weaving improves their weavability. Any warping oil traditionally used for textile yarns, especially polyamide or polyester yarns is suitable for the invention. The warping oil preferably contains as the predominant compound a mineral oil having a high flashpoint, a synthetic paraffin or a glycerol ester.

The lubricating composition can also include antistatic surfactants which are usually used in softening compositions.

The yarns forming the basic fabric of the coated fabric of the invention may be of natural, artificial and/or synthetic origin. They may also be of more than one origin: a yarn of polyamide and cotton fibers may be cited as an example.

These yarns are advantageously based on a thermoplastic polymer. As the thermoplastic (co)polymer suitable for the purposes of the invention may be cited by way of example: polyolefins, polyesters, polyalkylene oxides, polyoxyalkylenes, polyhaloalkylenes, poly(alkylene-phthalate or terephthalate)s, poly(phenyl or phenylene)s, poly(phenylene oxide or phenylene sulfide), poly(vinyl acetate)s, poly(vinyl alcohol)s, poly(vinyl halide)s, polyvinylnitriles, polyamides, polyimides, polycarbonates, polysiloxanes, polymers of acrylic or methacrylic acid, polyacrylates or methacrylates, natural polymers which are cellulose and its derivatives, synthetic polymers such as synthetic elastomers, or thermoplastic copolymers comprising at least one monomer identical to any one of the monomers included in the abovementioned polymers, and the blends and/or alloys of all these (co) polymers.

Other preferred thermoplastic polymers of the invention that may be cited include semicrystalline or amorphous polyamides, such as aliphatic polyamides, semiaromatic polyamides and more generally linear polyamides obtained by polycondensation between an saturated aliphatic or aromatic diacid and an aromatic or saturated aliphatic primary diamine, polyamides obtained by condensation of a lactam or of an amino acid, and linear polyamides obtained by condensation of a mixture of these various monomers.

More precisely, these copolyamides may for example be poly(hexamethylene adipamide), polyphthalamides obtained from terephthalic and/or isophthalic acid, such as the polyamide sold under the trade name AMODEL, or copolyamides obtained from adipic acid, hexamethylene diamine and caprolactam.

The thermoplastic polymer is advantageously a polyester such as poly(ethylene terephthalate) (PET), poly(propylene terephthalate) (PPT), poly(butylene terephthalate) (PBT) and copolymers and blends thereof.

Still more preferably, the thermoplastic polymer is selected from the group of (co)polyamides comprising: polyamide 6, polyamide 6,6, polyamide 4, polyamide 11, polyamide 12, polyamides 4-6, 6-10, 6-12, 6-36, 12-12 and copolymers and blends thereof.

The yarns may be based on a blend of thermoplastic polymers or thermoplastic copolymers.

The yarns may include additives such as reinforcing fillers, flame retardants, UV stabilizers, heat stabilizers, mattifying agents such as titanium dioxide, bioactive agents, etc.

The overall linear density of yarns forming the basic woven or knit fabric of the coated woven or knit fabric of the invention may be chosen from the full range of normal yarn linear densities, for example between 10 dtex and 2500 dtex, advantageously between 10 and 1100 dtex. In the field of safety air bags, the overall linear density is advantageously between 100 and 950 dtex.

The linear density of the filaments of the yarn can be chosen from the full range of normal yarn linear densities. The linear density of the filaments is generally greater than or equal to 0.3 dtex. It is usually less than the dtex equivalent of a diameter of 800 microns in the case of large-diameter monofilaments. In the case of safety air bags, the yarns are generally multifilamentary and the linear density of the filaments is advantageously between 1.5 and 7 dtex.

The yarns forming the basic woven or knit fabric of the coated woven or knit fabric of the invention may be prepared by the method comprising of the following steps:
1) spinning the constituent material of the yarn
2) optionally drawing the yarn
3) optionally texturizing the yarn and
4) treating the yarn with the aid of a lubricating composition as described above.

The spinning step 1) is carried out by any method known to those skilled in the art.

If the material of the yarn is a thermoplastic polymer, step 1) is advantageously a step of spinning the polymer in the molten state.

The yarns can undergo a drawing. Thus, the yarn can be drawn along the spinning pathway by any known method, at the desired ratio depending upon the orientation and mechanical properties which it is desired to impart the yarn. It can also be simply pre-oriented or oriented during spinning based on the final winding speed. This can be done directly or passed through rollers to control the winding tension, if this is found useful or necessary. Step 2) can be realized integrally or non-integrally with the spinning.

The winding speed is generally between 100 and 8000 m/min, advantageously between 600 and 5000 m/min, and preferably between 700 and 4000 m/min.

The texturizing step 3) can be done by any method known to those skilled in the art.

The treatment step 4) can be done before or after the optional drawing step. The treatment step 4) can also be done before or after the optional texturizing step 3). The composition used for the treatment in step 4) is usually in the form of a liquid. It may in particular be an oil, a solution, an emulsion or a dispersion in a liquid.

In the case of a multifilamentary yarn, the treatment allows to improve the mutual cohesion of the filaments.

The treatment of step 4) can be done by normal techniques such as deposition by rollers or slotted nozzles. Common techniques which may be cited by way of example without implying any limitation, include the technique of treating the raw fiber by roller, by spray or vaporization, by soaking, the pad-finishing technique, and any method used in the textile industry for processing synthetic fibers. This treatment can be carried out at various steps in the manufacture of yarns. These include all steps in which softening products are traditionally added. The additive can thus be applied at the bottom of the spinning machine before winding. Also, in the case of so-called “fiber” processes, the additive can be applied before, during or after the steps of drawing, creping or drying, etc.

In certain cases it may also be advantageous to put the yarn through an first beforehand treatment (a pretreatment) according to methods known to those skilled in the art in order to help the composition adhere to the yarn. Furthermore, consideration may be given to putting the yarn through other chemical or physical treatments such as irradiation, dyeing and so forth before or after the treatment of step 4).

The basic fabric of the invention advantageously has a weight per unit area of 40 to 400 g/m². The fabric, especially in the case of safety air bags, generally has a number of yarns per cm of fabric of between 10 and 30.

The woven fabric or knit fabric of the invention is advantageously coated with a silicone.

The invention also relates according to a second object to a method of obtaining a coated woven fabric or knit fabric for a safety air bag comprising the following steps:
weaving yarns having a lubricating composition present on at least part of their surface, the proportion of lubricating composition (solids content) being from 0.3 to 0.9% by weight (including the boundary values) relative to the weight of the yarn, weaving being performed on a weaving loom in order to make a basic warp and weft fabric, or knitting these yarns to make a basic knit fabric;
coating the basic woven fabric or knit fabric with an elastomer on at least one surface of the basic woven fabric or knit fabric.

Everything described above relating to the definition of the yarns forming the basic woven or knit fabric of the coated woven or knit fabric of the invention applies here to the yarns of the woven or knit fabric.

The yarns used to produce the basic woven or knit fabric may all be the same as each other or may differ from each other. The yarns described above are at least the warp of the fabric, and are advantageously both the warp and the weft of the fabric.

The yarns can be used for example as warp yarns on industrial weaving looms. They make it advantageously possible to produce a fabric without any sizing step. They advantageously make it possible to produce a fabric without any sizing step or washing step.

When used as warp yarns, the yarns can easily be set up either for direct warping or for sectional warping without the need for sizing and can be woven on all types of weaving loom, particularly industrially used high-speed looms.

In some cases, when for example the yarn is to be woven on looms which put the warp yarns under high stress, it may be preferable to oil the yarns with any commonly used product before weaving them.

The basic fabric is advantageously produced on a dry weaving loom, such as an air jet loom, a single or double rapier loom or a projectile loom.

The step of coating the basic fabric with an elastomer is known to those skilled in the art.

The yarns described above are particularly useful in the field of coated woven fabrics or coated knit fabrics for safety air bags, and this is the third object of the invention. These fabrics are advantageously made without any sizing step, and preferably without any washing step, which simplifies the method of making these articles and reduces the cost of the method. The yarns described above are particularly useful for making woven fabrics or knit fabrics for safety air bags coated with a silicone.

Additionally, these fabrics can also be produced without a heat treatment step. A heat treatment step is generally performed on the fabrics to give them dimensional stability. This heat treatment step is generally performed at the same time as the fabric drying step, which drying step is necessary when a washing step has been performed on the fabric. With the present invention, if the washing step is omitted, the drying step is no longer necessary. The heat treatment step can therefore be performed simultaneously with a step occurring later in the method, particularly when using the woven fabric or knit fabric for safety air bag. The step can be performed for example after the fabric has been coated with the elastomer; it is advantageously performed simultaneously with the elastomer crosslinking step.

The presence of the lubricating composition on the surface of the yarns has no influence on later treatments which the fabric may undergo, as when for example the fabric is used as a basic fabric for a coated fabric for safety air bags. As an example of a later treatment a coating with an elastomer etc may be cited. In particular the properties of abrasion resistance and crease resistance (scrub test) are not adversely affected.

Lastly, the invention relates in a fourth object to safety air bags comprising the coated woven fabric or knit fabric of the invention.

Other details or advantages of the invention will become more apparent in the light of the examples given below purely for illustration.

### Coating the Fabrics in Order to Assess Them

A laboratory doctor blade is used to coat the fabric with a Silicone resin sold under the name RHODORSIL® TCS 7510 A and B by Rhodia Silicones. The deposition ratio is approximately 40±10 g/m² (solids content).
The coated fabric is weighed in order to calculate the deposition ratio
The sample is then heat treated in an oven at 180° C. for 80 seconds
It is then removed and left in ambient air.
A 5×10 cm² sample is cut off and evaluated by the Scrub Test.

### Scrub Test: Determination of Crease Resistance (According to ISO Standard 5981)

This test characterizes the crease and abrasion resistance of a coated fabric.

It consists in subjecting the fabric both to a shearing movement in which two jaws squeeze the two opposite edges of a specimen and move in a reciprocating manner with respect to each other, and to an abrasion by contact with a mobile support.

### EXAMPLES

The polyamide 66 which is used is a post-condensed polyamide 66 containing 0.02% titanium dioxide, of relative viscosity 3.25 (measured at a concentration of 10 g/L in 96% sulfuric acid).

This polymer is introduced and melted using an extruder. The molten blend is then spun to produce a continuous 700 dtex yarn comprising 105 filaments by an integrated spinning/drawing process. After extrusion, the filaments are air-cooled before being passed over a guide for deposition of the softening product. They are then brought together.

The softening composition is deposited in the form of a pure oil that has been heated to approximately 55° C.

The yarn is then taken up at 650 m/min, hot-drawn in two stages to a ratio of 4.5, relaxed, and intermingled before being wound onto a reel at 2900 m/min.

The resulting yarn has the following characteristics (according to DIN standard 53834):
Tenacity: 82.5 cN/tex
Elongation at break: 21.5%
Shrinkage in hot air at 180° C.: 6.8%
Intermingling: 16 nodes/m

The linear density of softening product on the yarn is measured using an NMR method by calibration.

A fabric is then prepared from these yarns, using an air jet loom or rapier loom.

Various softening compositions (nature and amount) were tested. These and the results obtained are described above.

### Comparative Example

Softening composition: product sold by Takemoto company under the name Délion F8505®.

Average applied amount of softening product in the reels of yarn (measured as weight relative to the weight of the yarn): 0.9% (minimum amount on the yarn surface: 0.6% by weight relative to the weight of the yarn, maximum amount on the yarn surface: 1.2% by weight relative to the weight of the yarn). The yarn is woven on a Rapier loom. The fabric obtained has a structure of 17*16 yarns/cm and a weight per unit area of 250 g/m².

Warping and the behavior in spinning are satisfactory, weaving being done without stoppages.

Result of the scrub test (in the number of creases): 100

The fabric obtained after coating is dimensionally stable.

### Example 1

Softening composition: product sold by Cognis company under the name Stantex 6414®.

Average amount of softening product in the reels of yarn (measured as weight relative to the weight of the yarn): 0.7% (minimum amount on the yarn surface: 0.5% by weight relative to the weight of the yarn, maximum amount on the yarn surface: 0.9% by weight relative to the weight of the yarn). The yarn is woven on an air jet loom. The fabric obtained has a structure of 13.5*14 yarns/cm and a weight per unit area of 200 g/m².

Warping and the behavior in spinning are satisfactory, weaving being done with two stoppages in 100 m. The length of the fabric is 410 m.

Result of the scrub test (in the number of creases) 800

The fabric obtained after coating is dimensionally stable.

### Example 2

Softening composition: product sold by Cognis company under the name Stantex 6414®.

Average amount of softening product in the reels of yarn (measured as weight relative to the weight of the yarn): 0.6% (minimum amount on the yarn surface: 0.3% by weight relative to the weight of the yarn, maximum amount on the yarn surface: 0.9% by weight relative to the weight of the yarn). The yarn is woven on an air jet loom. The fabric obtained has a structure of 13.5*14 yarns/cm and a density of 200 g/m².

Warping and the behavior in spinning are satisfactory, weaving being done with two stoppages in 100 m. The length of the fabric is 260 m.

Result of the scrub test (in the number of creases): 1200.

The fabric obtained after coating is dimensionally stable.

In all cases the behavior in spinning and weaving is satisfactory. The results of the scrub test are very good when the amount of softening composition of the yarn is low.

1. A coated woven fabric for a safety air bag, obtained by coating a basic woven fabric with an elastomer on at least one surface of the basic woven fabric, characterized in that the basic woven fabric is formed of a yarn having a lubricating composition on at least part of its surface, the average proportion of lubricating composition (solids content) being from 0.2 to 0.7% (including the boundary values) by weight relative to the weight of the basic woven fabric, and in that said yarn forms both the warp and weft of the fabric;
or a coated knit fabric for a safety air bag, obtained by coating a basic knit fabric with an elastomer on at least one surface of the basic knit fabric, characterized in that the basic knit fabric is formed of a yarn having a lubricating composition on at least part of its surface, the average proportion of lubricating composition (solids content) being from 0.2 to 0.7% by weight (including the boundary values) relative to the weight of the basic knit fabric.

2. The woven fabric or knit fabric as claimed in claim 1, characterized in that the average proportion of lubricating composition (solids content) is from 0.3 to 0.7% by weight (including the boundary values) relative to the weight of the basic woven or knit fabric.

3. The woven fabric or knit fabric as claimed in claim 1, characterized in that the proportion of lubricating composition (solids content) present on the surface of each yarn forming the basic woven or knit fabric is from 0.3 to 0.9% by weight (including the boundary values) relative to the weight of the yarn.

4. The woven fabric or knit fabric as claimed in claim 1, characterized in that the lubricating composition is a softening composition.

5. The woven fabric or knit fabric as claimed in claim 1, characterized in that the yarns forming the basic woven or knit fabric are thermoplastic polymer-based.

6. The woven fabric or knit fabric as claimed in claim 5, characterized in that the yarns forming the basic woven or knit fabric are based on polyester or polyamide.

7. The woven fabric or knit fabric as claimed in claim 1, characterized in that the overall linear density of the yarns forming the basic woven or knit fabric is from 100 to 950 dtex.

8. The woven fabric or knit fabric as claimed in claim 1, characterized in that the linear density of the fibers of the yarns forming the basic woven or knit fabric is from 1.5 to 7 dtex.

9. The woven fabric or knit fabric as claimed in claim 1, characterized in that it is coated with a silicone.

10. A method of preparing a coated woven fabric or knit fabric for a safety air bag comprising the following steps:
weaving a yarn having a lubricating composition present on at least part of its surface, the proportion of lubricating composition (solids content) being from 0.3 to 0.9% by weight (including the boundary values) relative to the weight of the yarn, the weaving being performed on a weaving loom in order to obtain a basic fabric in which said yarn forms both the warp and the weft, or knitting this yarn to make a basic knit fabric;
coating the basic woven fabric or knit fabric with an elastomer on at least one surface of the basic woven fabric or knit fabric.

11. The method as claimed in claim 10, characterized in that it does not include any sizing step.

12. The method as claimed in claim 10, characterized in that it does not include any step of washing the woven or knit fabric.

13. The method as claimed in claim 10, characterized in that the weaving loom is a dry weaving loom, such as an air jet loom, a single or double rapier loom or a projectile loom.

14. The method as claimed in claim 10, characterized in that the lubricating composition is a softening composition.

15. The method as claimed in claim 10, characterized in that the yarns are thermoplastic polymer-based.

16. The method as claimed in claim 10, characterized in that the yarns forming the basic woven or knit fabric are based on polyester or polyamide.

17. A method comprising use of a yarn for preparing coated woven fabrics for safety air bags, characterized in that the yarn has a lubricating composition present on at least part of its surface, the proportion of lubricating composition (solids content) being from 0.3 to 0.9% by weight (including the boundary values) relative to the weight of the yarn, and in that said yarn forms both the warp and weft of the fabric; or for preparing coated knit fabrics for safety air bags, characterized in that the yarn has a lubricating composition present on at least part of its surface, the proportion of lubricating composition (solids content) being from 0.3 to 0.9% by weight (including the boundary values) relative to the weight of the yarn.

18. The method as claimed in claim 17, characterized in that the lubricating composition is a softening composition.

19. The method as claimed in claim 17, characterized in that the fabric is coated with a silicone.

20. A safety air bag comprising the coated woven fabric or knit fabric as claimed in claim 1.
